(19) United States
(12) Patent Application Publication
(10) Pub. No.: US 2024/0426427 A1
(43) Pub. Date: Dec. 26, 2024

(54) COMPRESSED AIR ENERGY STORAGE AND REGENERATION THEREOF

(71) Applicant: University of Virgina Patent Foundation, Charlottesville, VA (US)

(72) Inventor: Eric Loth, Charlottesville, VA (US)

(21) Appl. No.: 18/707,450

(22) PCT Filed: Nov. 4, 2022
(86) PCT No.: PCT/US2022/079264

§ 371 Date: May 3, 2024

Related U.S. Application Data
(60) Provisional application No. 63/276,063, filed on Nov. 5, 2021.

(51) Int. Cl. F17C 5/06; F17B 1/10; F17B 1/12; F17B 1/26

(52) U.S. Cl. CPC F17C 5/06; F17B 1/10; F17B 1/12; F17B 1/26; F17C 2203/0329; F17C 2221/031; F17C 2227/0135; F17C 2227/0164; F17C 2227/0379

(57) ABSTRACT

Systems and techniques for compressed air energy storage and regeneration thereof are described herein. A compressor for compressed air energy storage and regeneration thereof can include a housing, a actuator, and a heat exchanger. The housing can define a volume. The actuator can be operable to expand the volume and compress the volume. The heat exchanger can be located at least partially within the housing. The heat exchanger can be configured to compress when the actuator compresses the volume, expand when the actuator expands the volume, and transfer heat with a working fluid.

### CLAIM OF PRIORITY

This patent application claims the benefit of priority, under 35 U.S.C. Section 119(e), to Eric Loth U.S. Patent Application Ser. No. 63/276,063, entitled “SYSTEM AND METHOD FOR ENABLING INSOTHERMAL COMPRESSED AIR ENERGY STORAGE (ICAES) AND REGENERATION THEREOF,” filed on Nov. 5, 2021 (Attorney Docket No. 02601-03), which is hereby incorporated by reference herein in its entirety.

### STATEMENT REGARDING FEDERALLY SPONSORED RESEARCH OR DEVELOPMENT

This invention was made with government support under award number DE-AR0000667 awarded by the Department of Energy. The government has certain rights in this invention.

### TECHNICAL FIELD

Embodiments described herein generally relate to energy storage and, more specifically, to compressed air energy storage and regeneration thereof.

### BACKGROUND

Renewable energy sources (e.g., wind, solar, and the like) are gaining popularity. As renewable energy becomes more prevalent, storage of energy becomes more important because wind and solar energy are not available around the clock. Compressed air energy storage (CAES) has been proposed as a low-cost technique to store energy. However, low round-trip efficiency (e.g., less than 50%) can occur when expansion and compression are adiabatic (or near adiabatic).

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 is a block diagram of an example of a system for compressed air energy storage and regeneration thereof, according to an embodiment.

FIG. 2 illustrates a schematic diagram of a portion of an example of a compressor.

FIG. 3 illustrates a schematic diagram of a portion of an example of a compressor.

FIG. 4 illustrates a schematic diagram of a portion of an example of a compressor.

FIG. 5 illustrates a schematic diagram of a portion of an example of a compressor.

FIG. 6 illustrates an enlarged schematic diagram of an example of a heat exchanger.

FIG. 7 illustrates a schematic diagram of a portion of an example of a compressor.

FIG. 8 illustrates a schematic diagram of a portion of an example of a compressor.

### DETAILED DESCRIPTION

The present disclosure relates to systems and methods of compressed air energy storage and regeneration thereof. Compressed air energy storage (CAES) can supplement renewable energy sources (e.g., wind, water, solar, or the like), when the energy sources (e.g., wind, the sun, currents, or the like) are not available. In one approach for performing CAES, two or even three-stage compressors can be used to obtain relatively high compression ratios, for example, 50:1, to provide a specified energy storage per unit volume. However, performing CAES can present various challenges. For example, a round-trip (e.g., compression, storage, and expansion) efficiency of CAES can be low (e.g., less than 50%) if the compression or expansion cycles are adiabatic. This low efficiency can stem from a lack of heat transfer. Heat built up due to adiabatic (or near adiabatic) compression can be lost over time in the storage container before the energy can be extracted. The present inventor has recognized, among other things, that isothermal (or near isothermal) compressed air energy storage (ICAES) can be used to increase storage and regeneration efficiency, at least in part by avoiding generating heat during compression. With suppression or elimination of heat generation during compression and with suppression of heat extraction during expansion, round-trip efficiencies can approach above 90%. High rates of heat transfer within the chamber of the compressor are established to achieve near isothermal (nearly constant gas temperature), such as for both compression and expansion.

In an example, a compressible heat exchanger can be installed within a chamber of a compressor. The compressible heat exchanger can be made from a polymer, metal, carbon fiber, ceramic, glass, any combination thereof, or the like. The compressible heat exchanger can be a foam, mesh, spiral, any other configuration with a large surface area, any combination thereof, or the like. The compressible heat exchanger can be installed within the chamber of the compressor, can stay within the chamber of the compressor, and need not be recharged, injected, or stabilized.

In an illustrative example, a compressor can have a chamber having a length of 30 cm and a diameter of 30 cm, and the compressor can have a cycle frequency of one Hertz (Hz).

To enhance ICAES efficiency, a heat exchanger material with high surface area and mass can be included in the process (e.g., within a chamber of a piston) so the resulting specific heat ratio (γₘᵢₓ) of the mixture (of gas in the chamber and the heat exchanger) approaches near unity. In the absence of a heat exchanger, a specific heat ratio based on the gas (γ_{gas}) may dominate. In such an example of a gaseous medium, a specific heat can be 1.4, which is reasonable for diatomic gasses and air in moderate conditions. Accordingly, the inclusion of a heat exchanger can improve the compressed air system efficiency by reducing the specific heat ratio from 1.4 to 1.0.

A “Crowe number” of the heat transfer material (Cr) can be defined by:

$$Cr = \frac{{τ}_{HX}}{{τ}_{comp}} \qquad ( 1 )$$

where τ_{HX} can be a thermal response time of the material (τ_{HX}) and τ_{comp} can be the compression time of the process or can be set as the expansion time for an expansion process. A small Crowe number (much less than unity) ensures that the heat exchanger can respond quickly (relative to compression or expansion times) to ensure heat transfer can take place. In an example with a small Crowe number, e.g., 0.01 or less, the mixture specific heat ratio can be given by a “Kersey limit,” which can be defined as a function:

$${γ}_{mix} = \frac{γ ( 1 + c * η )}{( 1 + γ c * η )} \qquad ( 2 )$$

where c* can be a ratio of a specific heat of the heat exchanger material relative to that of the gas and η can be a ratio of the heat exchanger mass to gas mass. Polymers can typically have a c* of 1 when in air, and air can typically have a specific heat ratio of 1.4. Thus, in an illustrative example, a specific heat ratio within the chamber can be approximately 1.04 for a mass loading with η=4. With a Cr of 0.01 or less and a compression time of 0.5 seconds, τ_{HX} can be 0.5 milliseconds or less.

Compressible heat exchangers (CHX) can be used in the compression chamber for long periods without requiring replacement or removal. The use of a CHX configuration as described herein can have the benefits of having high mass and high surface area within the chamber combined with small geometric features to expedite heat transfer to the air to achieve nearly isothermal compression and expansion. For example, the CHX can provide a high surface area for heat transfer compared to air within the chamber.

As an illustrative example, a solid polymer foam—with a specified mass or specified density—can be inserted within the chamber to help encourage isothermal compressed air energy development. For example, some polymer foams can have densities of about 100 kilograms per cubic meter (kg/m³). Accordingly, a polymer foam can provide n values ranging from about 80 to 4. In examples, such a compression system can increase the air density, for example, from 1.23 kg/m³ to 24.6 kg/m³, if the compression system includes a 20:1 pressure ratio and isothermal conditions.

The CHX can also provide a large initial mass in the chamber compared to the working fluid, which can result in a small Crowe number (e.g., much less than unity). The CHX can include a buoyancy plate or bracket with enough force to counteract the restitution force of the heat exchanger when compressed to maintain the small Crowe number. For example, the CHX can be made of buoyant material or include a buoyant bracket on the bottom of the CHX such that the liquid piston can compress the chamber, and most of the CHX within the chamber can stay above a liquid line and provide active area for air heat transfer during the compression and expansion processes.

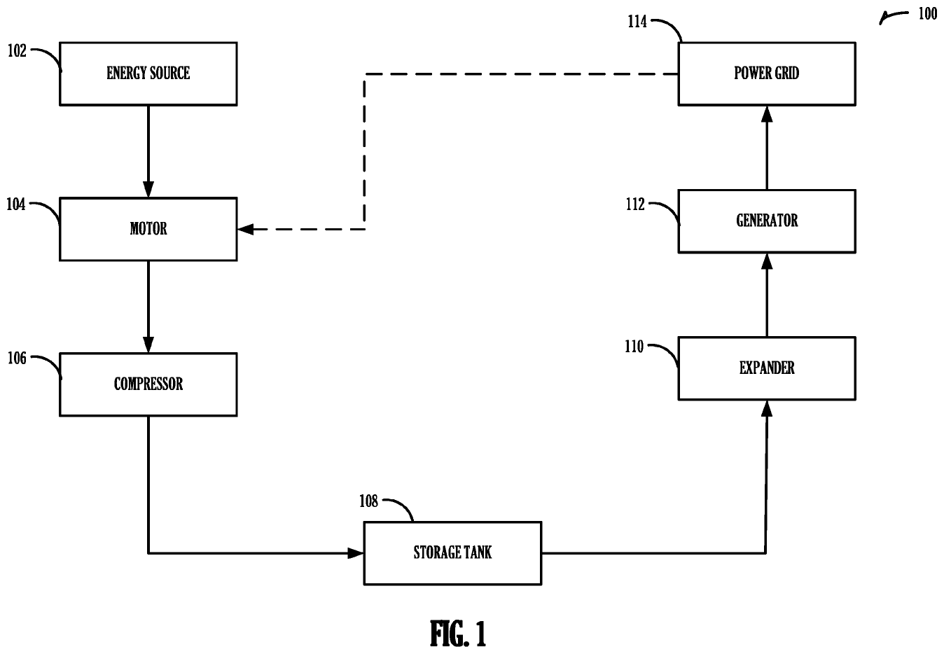

FIG. 1 is a block diagram of an example of an environment including a system for compressed air energy storage and regeneration thereof, according to an embodiment. The system 100 can be a system for compressed air energy storage and regeneration thereof. The system 100 can include an energy source 102, a motor 104, a compressor 106, a storage tank 108, an expander 110, a generator 112, and a power grid 114.

The energy source 102 can be configured to provide energy (e.g., heat, light, electrical, mechanical, any combination of them, or the like) to the system 100. For example, the energy source 102 can be a renewable energy source (e.g., a wind turbine, solar panel, hydroelectric dam, any combination of them, or the like). In another example, the energy source 102 can be the power grid 114. For example, the power grid 114 can be the energy source 102 during non-peak energy demand because there can be excess energy available from the power grid 114. For example, the system 100 can extract excess energy from the power grid 114 and store that extra energy for use when there is an energy shortage.

The motor 104 can be configured to convert the energy provided from the energy source 102 into an energy source that can operate the compressor 106. Thus, in an example, the motor 104 can be powered by the energy source 102 and serve as a prime-mover. In another example, the motor 104 can be powered by the power grid 114. The motor 104 can convert electricity from the energy source 102 to mechanical energy to operate the compressor 106. In another example, the motor 104 can operate any actuator of the compressor 106 such that the energy source 102 can power the compressor 106 via the motor 104.

The compressor 106 can be configured to compress a working fluid for storage of energy in the form of a compressed or condensed working fluid. In an example, the compressor 106 can be operatively connected to the motor 104. The compressor 106 can be any compressor (e.g., rotary screw, vane, reciprocating, any combination of them, or the like) that can process a working fluid (e.g., air, or any combination of liquids and gases, or the like). In examples, the working fluid can be air, fluid, or a combination thereof, that can be compressed, and stored in a storage tank to store energy.

The storage tank 108 can be configured to store the compressed working fluid until the compressed working fluid is processed for recovery of energy by expansion or evaporation of the working fluid. In an, the storage tank 108 can be an above ground pressure vessel. In another example, the storage tank 108 can be an underground pressure vessel. The storage tank 108 can also be a natural storage site (e.g., a salt cavern, a rock formation such as aquifer, or the like). The storage tank 108 can be fluidically connected to the compressor 106 such that the storage tank 108 can receive the compressed working fluid. The storage tank 108 can also be fluidically connected to an expander 110 such that the stored compressed working fluid can be pre-heated by the expander 110 or other heat exchanger arrangement.

The expander 110 can be configured to pre-heat the compressed working fluid before an expansion cycle to improve efficiency of the energy extraction from the compressed working fluid. In an example, the expander 110 can receive a heating fluid from waste generated by the parts of the system 100. For example, exhaust heat from the motor 104 or the generator 112 can provide heating fluid for the expander 110 to be transferred to the working fluid from the storage tank 108.

The generator 112 can be configured to be driven by expansion of the working fluid to convert the energy stored in the compressed working fluid into an energy that can be used on the power grid 114. In an example, the generator 112 can be a turbine generator, or any generator that can turn a compressed working fluid into electrical energy, at least in part by the expansion of the working fluid.

The power grid 114 can be a general reference to an energy distribution system or network having multiple sources and loads, spanning a structure, a portion of a city, an entirety of a city, a state, or a country. In an example, the power grid 114 can provide energy to houses, businesses, or other loads, such as a basis where such loads vary defining varying demand. In an example, the power grid 114 can extract energy from the system 100 at times of relatively higher demand to supplement an energy deficiency or otherwise meet such demand, including providing stabilization of line voltage or line frequency provided by power grid 114.

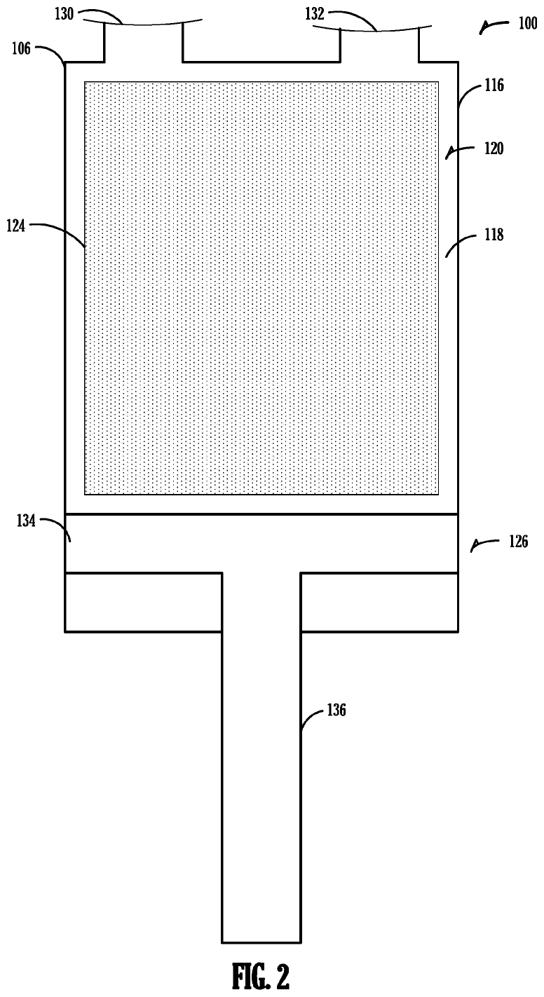

The above discussion provides an overview of subject matter of the present patent application. It is not intended to provide an exclusive or exhaustive explanation of the invention. The description below is included to provide further information about the present patent application. The compressible heat exchanger for isothermal compressed air energy storage will be discussed with reference to FIGS. 2-8 below.

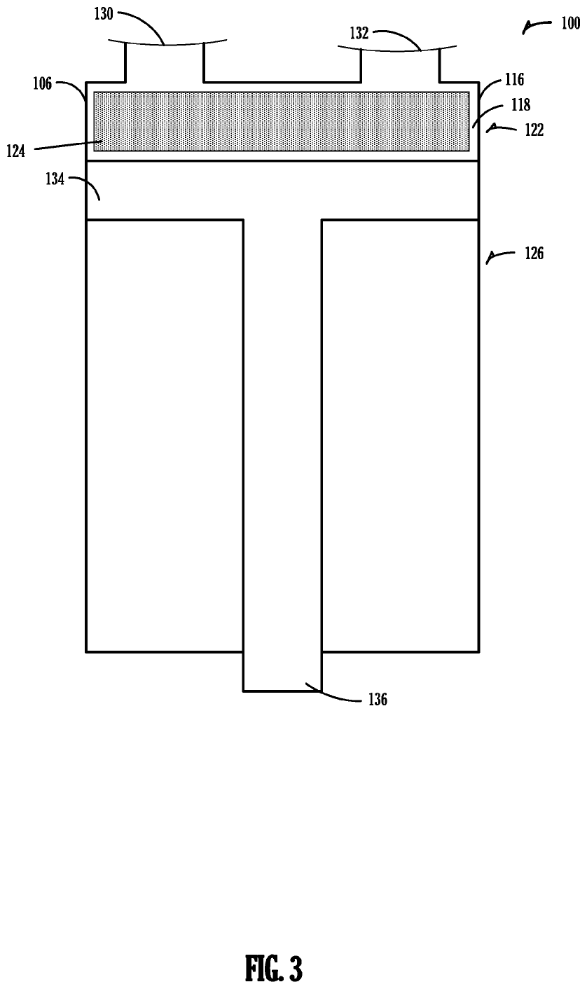

FIGS. 2 and 3 will be discussed together below. FIG. 2 illustrates a schematic diagram of a portion of an example the compressor 106. FIG. 3 illustrates a schematic diagram of a portion of an example of the compressor 106.

The system 100 can include different examples of the compressor 106. For example, the compressor 106 can be a one stage, two stage, three stage, or more compressor. Each stage of the compressor 106 can include a housing 116. The housing 116 can define a chamber 118. Each stage of the compressor 106 can be operable to pressurize a working fluid (e.g., air, any combination of liquid and gas, or the like) by altering a volume within the chamber 118 between an expanded state 120 (in FIG. 2) and a compressed state 122 (in FIG. 3). In examples, the expanded state 120 of the volume of the chamber 118 can be at the beginning of a cycle of the compressor 106 and the compressed state 122 of the volume of the chamber 118 can be at an end of a cycle of the compressor 106 such that a non-compressed working fluid can fill the chamber 118 of the compressor 106 at the expanded state 120 and a compressed working fluid can fill the chamber 118 of the compressor 106 at the compressed state 122.

As shown in FIGS. 2 and 3, the system 100 can include a heat exchanger 124 and a mechanical piston, actuator, or any other mechanism that can alter the volume of the chamber 118 (hereinafter the actuator 126). In an example, the heat exchanger 124 can be configured to compress when the actuator 126 compresses the volume, expand when the actuator 126 expands the volume, and transfer heat with a working fluid while being compressed and expanded within the chamber 118 by the actuator 126.

In example, the heat exchanger 124 can be installed within the chamber 118. For example, the heat exchanger 124 can be configured to operate during both compression (e.g., when energy is being stored) and expansion (e.g., when energy is being regenerated). The heat exchanger 124 can be inserted through any opening in the housing 116. In an example, the heat exchanger 124 can be configured to transfer heat between the working fluid and the heat exchanger 124. For example, the heat exchanger 124 can transfer heat from the working fluid, such as while the working fluid is being compressed in a first cycle, to prevent the working fluid from heating, and can transfer heat to the working fluid, such as while the working fluid is being drawn into the chamber 118 to begin a second cycle, to cool the heat exchanger 124.

In examples, the heat exchanger 124 can be any size to fill some or all of the chamber 118. As an illustrative example, the heat exchanger 124 can fill 30% of the volume of the chamber 118 when the chamber 118 is in the expanded state 120. Having the heat exchanger 124 in just 30% of the volume of the chamber 118 can make the installation of the heat exchanger 124 easier within the chamber 118 or can reduce an amount of work to compress the heat exchanger 124. Such a configuration can still maintain heat transfer between the working fluid and the heat exchanger 124 because 70% of the heat transfer generally occurs in the last 30% of the stroke of the actuator 126. Generally, as a volume of the chamber 118 moves to a latter portion of the compressed state 122, the heat exchanger 124 can occupy all or most of the volume of the chamber 118. Over the transition from the expanded state 120 to the compressed state 122, the heat exchanger 124 can occupy on average, 65% of the volume of the chamber 118, as an illustrative example.

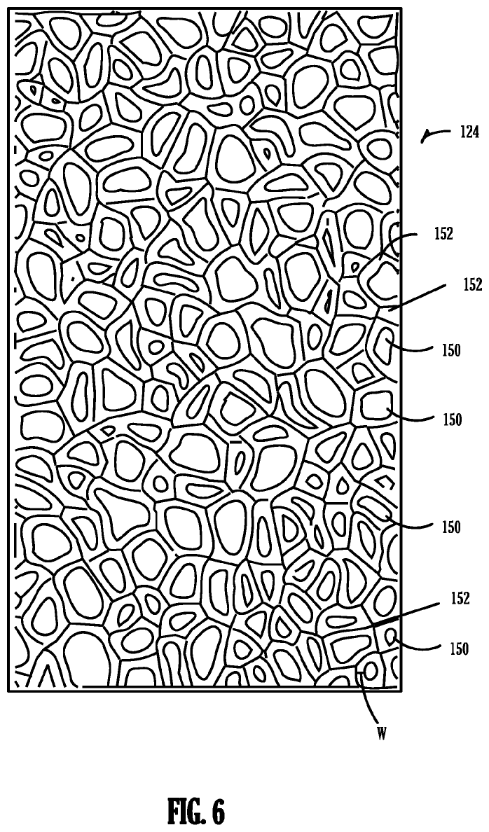

In an example, the heat exchanger 124 can be configured to expand and compress as the volume of the chamber 118 changes from the expanded state 120 and the compressed state 122. In an example, the heat exchanger 124 can have a mass loading between 1 and 10, as compared to the working fluid in the chamber, for one stage of compression. The heat exchanger 124 will be discussed in greater detail below with reference to FIG. 6.

In an example, the system 100 can include an inlet valve 130 and an outlet valve 132. The inlet valve 130 can be configured to fluidically connect the chamber 118 to a working fluid source. When the inlet valve 130 fluidically connects the chamber 118 to the working fluid source, the chamber 118 can be filled with the working fluid when the chamber 118 is in the expanded state 120. The outlet valve 132 can be configured to fluidically connect the chamber 118 to a storage tank (e.g., the storage tank 108 in FIG. 1). The outlet valve 132 can direct the compressed working fluid from the chamber 118 to the storage tank when the chamber 118 is in the compressed state 122.

As shown in FIGS. 2 and 3, the actuator 126 of the compressor 106 can include a piston 134 and a piston rod 136. The piston 134 can be installed within the chamber 118. The piston rod 136 can extend through the housing 116. The piston rod 136 can be connected to the piston 134 and a motor (e.g., the motor 104 of FIG. 1) such that the motor actuates the piston rod 136, which can engage the piston 134 to alter the volume of the chamber 118 between the expanded state 120 and the compressed state 122. Rotary motion from the motor 104 can be converted to linear motion of the piston 134, such as with the use of a crank structure to provide a reciprocating compressor configuration. The inventor of the present disclosure is discussing the above mechanical systems as an example, and the inventor of the present disclosure recognizes that other mechanical compression systems can be used within the system 100.

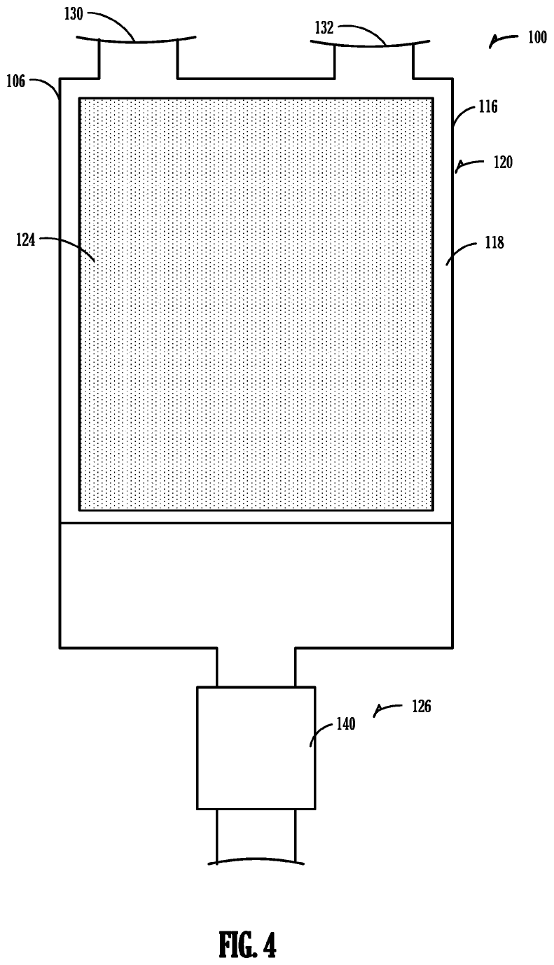

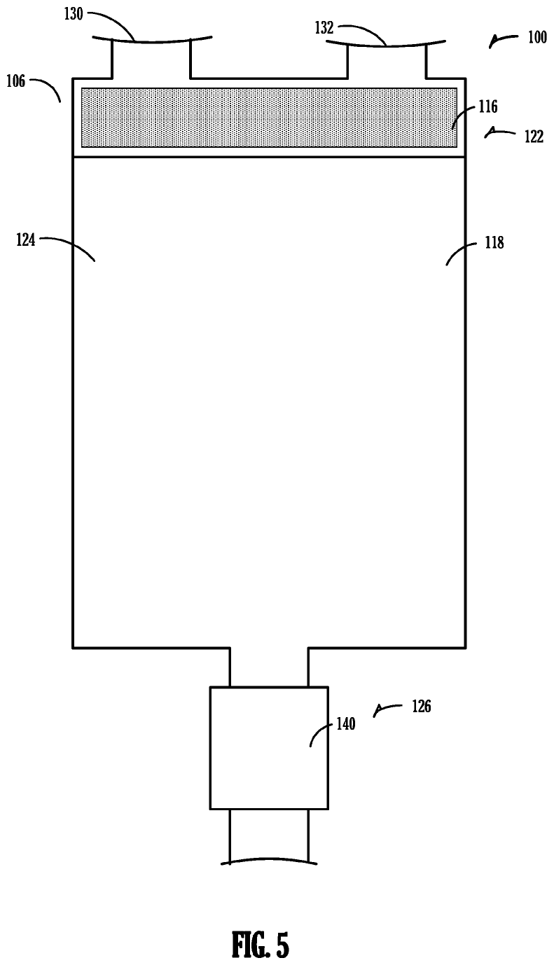

FIGS. 4 and 5 will be discussed together below. FIG. 4 illustrates a schematic diagram of a portion of an example of the compressor 106. FIG. 5 illustrates a schematic diagram of a portion of an example of the compressor 106.

In an example, the system 100 can include a pump 140. The pump 140 can be configured to move a liquid (e.g., the processing fluid) surface upwards in the chamber to compress the working fluid. At the end of a cycle, the pump 140 can be reversed to move the liquid surface of the processing fluid downwards to provide room within the chamber 118 for more working fluid. As the pump 140 is lowering the level of the processing fluid, the chamber 118 can be filled with the working fluid in preparation for the next cycle of the compressor 106.

In another example, the pump 140 can be integral to actuator 126 of the compressor 106. The pump 140 can be operatively connected to a motor (e.g., the motor 104 of FIG. 1). The pump 140 can also be fluidically connected to the chamber 118. For example, the pump can be operable to fill the chamber with a processing fluid to move the volume of the chamber 118 from the expanded state 120 to the compressed state 122 and pressurize the working fluid within the chamber 118.

The heat exchanger 124 can be designed to remain outside at least partially of the processing fluid. The heat exchanger 124 can remain outside at least partially of the processing fluid to maintain heat transfer between the heat exchanger 124 and the working fluid during the compression and expansion of the chamber 118. In an example, the heat exchanger 124 can be made from foam with enough buoyancy to float above the processing fluid. In another example, the heat exchanger 124 can have a bottom, for example, a buoyancy plate, bracket, base, or any other interface that can maintain the heat exchanger 124 above the processing fluid such that the heat exchanger 124 floats above the processing fluid. In yet another example, the chamber 118 can include a piston (e.g., the piston 134 of FIGS. 2 and 3). Here, the processing fluid can contact the piston to compress the working fluid and the heat exchanger 124 within the chamber 118. In examples, the processing fluid can be a fluid that will not mix with the working fluid. For example, the working fluid can be air and the processing fluid can be a liquid that will not mix with air. In another example, the working fluid can be a combination of a gas and a liquid, and the processing fluid can be a liquid that will not mix with the working fluid.

FIG. 6 illustrates an enlarged schematic diagram of an example of the heat exchanger 124. The heat exchanger 124 can be customized to match the performance specifications of a system (e.g., the system 100 in FIG. 1). For example, the heat exchanger 124 can be made from different materials, made in different sizes, or made in different configurations to accommodate the desired performance (e.g., one or more heat transfer characteristics) under the constraints (e.g., specified power to compress and power to move air through the heat exchanger 124) of the system.

In an example, the heat exchanger 124 can be made from a foam having breathable pores (shown here as pores 150). The heat exchanger 124 can also be made of a foam having structural ligaments (shown here as ligaments 152 that define the pores 150). In examples, the pores 150 can be open-cell pores such as to limit a restriction to airflow through the heat exchanger 124 and to increase a surface area of the heat exchanger 124 that will interact with the working fluid within the chamber 118. In examples, the ligaments 152 can be strands or wires that define the heat exchanger 124. In general, the heat exchanger 124 can be made such that air can traverse through the heat exchanger 124. Together the pores 150 and the ligaments 152 can provide a high surface area for the heat exchanger 124. In examples, the pores 150 can be very small, which can increase a surface area of the heat exchanger 124. As discussed above, the small surface area of the heat exchanger 124 can help reduce the Crowe number (e.g., to less than unity). The ligaments 152 can have a width W of less than 50 microns. In another example, the width W of the ligaments 152 can vary throughout the heat exchanger 124 to increase a surface area of the heat exchanger 124. In an example, the heat exchanger 124 can include an open-cell foam that can promote heat transfer and can have permeability. In another example, the heat exchanger 124 can include closed-cell foam.

In an example, the heat exchanger 124 can be made from a foam having open-cell pores. The heat exchanger 124 can also be made of foam having structural ligaments (strands or wires). In these examples, the pores or strands can be very small, such as to increase the surface area of the heat exchanger 124 and to minimize the small Crowe number (less than unity). The heat exchanger 124 can include an open-cell foam that can promote heat transfer and can have permeability.

The heat exchanger 124 can be customized to transfer heat within any compressor 106 as required by the system 100. However, in an illustrative example, the heat exchanger 124 can be made from a polymer foam with a density of about 19 kg/m³. So, the heat exchanger 124 can be made from a polymer foam including about 2% solid and 98% air by mass. Here, the heat exchanger 124 can have a density 16 times higher than air at sea level. When the heat exchanger 124 occupies only 30% of the volume of the chamber 118, the heat exchanger 124 can have a mass loading of about four (vs. mass of air in the chamber 118). The heat exchanger 124 can also have small pore sizes, which can translate to even smaller structural ligament widths. The small pore sizes of the heat exchanger 124 can provide high surface areas and mass, which can promote heat transfer between the heat exchanger 124 and the working fluid.

The work required to compress the heat exchanger 124 can be small compared to the work required to compress the air within the chamber 118, such as less than 2%. In another example, the work required to compress the heat exchanger 124 can be less than 5% the work required to compress the air within the chamber 118. In yet another example, the work required to compress the heat exchanger 124 can be less than 10% the work required to compress the air within the chamber 118.

In another illustrative example, the compressor 106 can include a second stage. For the compressor 106 with a second stage, a density of the air in the chamber can be ten-fold the density of air in a first-stage compressor. If the compressor with the second stage has the chamber 118 with similar geometry to the chamber 118 of the compressor 106 with a first stage, and if the heat exchanger has a mass loading of 4 in the compressor 106 that is first stage, this would result in a mass loading of 0.4 in the second stage compressor 106, which may be sufficient for a compression ratio of 5:1 for such a second stage as long as the Crowe number is much less than unity. However, a higher mass loading for the second stage would be more efficient. To achieve this, the heat exchanger 124 for a second stage of the compressor 106 can be made of foam or mesh with a higher density to achieve a mass loading of about one. This higher density can require about triple the force for compression, but this was shown above to be negligible for first stage, and even more so at the second stage of the compressor 106 because of the higher work involved in compressing air in the second stage. In addition, the heat exchanger in the second stage can be designed to fill more of the chamber 118 to increase the mass loading for the second stage of the compressor 106.

Another issue can be the pressure work to pass the air through the pores 150. The heat exchanger 124 can be customized to decrease air pressure loss across the heat exchanger 124. Reducing the pressure loss across the heat exchanger 124 can improve efficiency of the system 100 (FIG. 1). Generally, pressure drop (ΔP) is linearly proportional to the ratio of thickness (t) to permeability (k) of the heat exchanger and linearly proportional to the velocity (V) of the air passing though the heat exchanger; and power loss is proportional to pressure drop. For a typical foam, a 250 Pascal pressure drop over 25 mm thickness results in a pressure gradient of 10 kPa/m over a 5 cm×5 cm area (0.0025 m²).

In an illustrative example, the heat exchanger 124 can be made from foam with this pressure drop, which can result in a volumetric flow rate of 3 CFM (0.0014 m³/s), consistent with a velocity of 0.56 m/s for the above-referenced cross-sectional area. For example, when the heat exchanger 124 made from foam is compressed in a first stage of the compressor 106, the average velocity of the air can be generally based on the piston velocity, which can be related to total stroke distance over one cycle of compression stroke time. If this piston velocity is about 0.12 m/s, that is less than 0.25 of that reported for the standard test so the expected pressure gradient can be less than 2.5 kPa/m. In an illustrative example, the heat exchanger 124 can use a thickness of foam of 0.1 meter (100 mm), so the pressure drop can be about 0.25 kPa. Once the heat exchanger 124 is compressed, the permeability (k) of the foam can reduce. But the thickness can also reduce roughly with the same ratio, so the net pressure drop can be about the same, for example, less than 0.25 kPa.

In examples, the pressure work to compress the heat exchanger 124 can be force per distance, where force will be a product of pressure drop, cylinder area, and distance of work. In the illustrative example above, such work can be about 1.6 J. Again, this is negligible relative to the typical work to compress the air within the chamber 118 of the heat exchanger 124. Because the amount of work to compress the heat exchanger is negligible as compared to the work to compress air within the chamber 118 of the heat exchanger 124, air pressure loss due to the compression of the heat exchanger 124 should not be a significant contributor to efficiency loss.

The above calculations are simply illustrative of a single example and should not limit the disclosure. The Applicant has contemplated multiple variations of such calculations and contends that the scale of the calculations can be altered based on at least the scale of the compressor, the working fluid being used, and the energy requirements of the system.

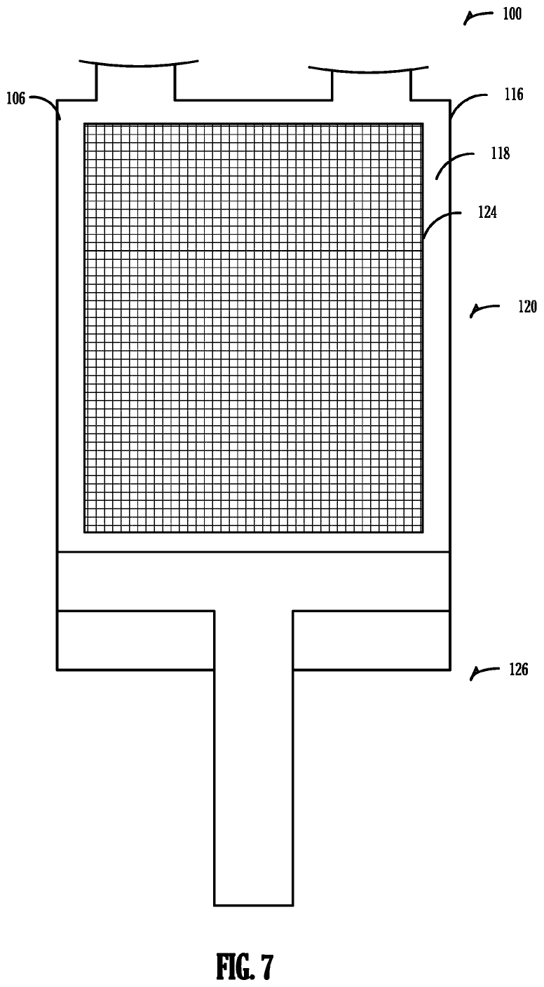

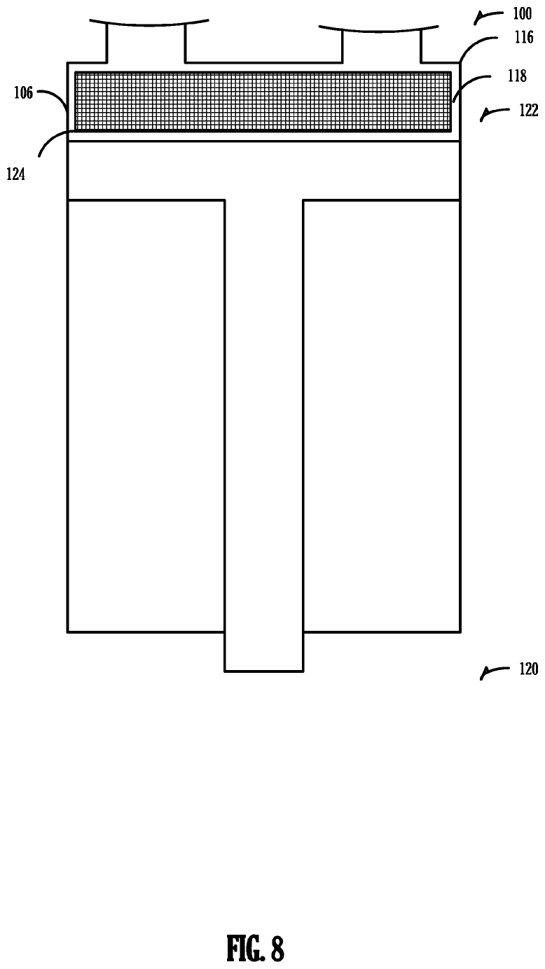

FIGS. 7 and 8 will be discussed together below. FIG. 7 illustrates a schematic diagram of another example of the heat exchanger 124 within the chamber 118. FIG. 8 illustrates a schematic diagram of another example of the heat exchanger 124 within the chamber 118.

As discussed above in FIGS. 2-6, the heat exchanger 124 can include a foam. For example, the heat exchanger 124 can include a breathable open-cell foam. The heat exchanger 124 can also include a breathable wire mesh, a wire, a foam embedded with a wire or wire mesh, a foam impregnated with ceramic or metal particles or carbon-fiber elements, any combination thereof, or the like. Similar considerations apply to wire-containing or mesh-containing examples as compared to the examples discussed above in relation to FIGS. 2-6. As such, wire-containing or mesh-containing examples of the heat exchanger 124 can be configured to expand and compress with the chamber 118 and transfer heat between the working fluid and the heat exchanger 124 in a manner similar to other examples described herein.

The wire-containing or mesh-containing examples of the heat exchanger 124 can be configured to increase a surface area of the heat exchanger 124, while reducing or minimizing work to compress the heat exchanger 124 and reducing or minimizing pressure drop efficiency loss. For example, the heat exchanger 124 made with a wire mesh can include one or more long wires spiraled around within the chamber 118. Each of the wires can include a length much larger than a diameter of the wire. In an illustrative example, the breathable wire mesh can be breathable because the wire mesh can have a length that is much longer than the diameter of the wire. For example, the length of the wire can be ten, twenty, thirty, forty, one hundred, or more times the diameter of the wire. The long wires, as compared to the diameter of the wires, helps to increase the surface area, which can help improve heat transfer between the working fluid and the heat exchanger 124. Moreover, the relatively small wire diameters as compared to the length of the wire can help to reduce the Crowe number, which can also promote heat transfer between the working fluid and the heat exchanger 124.

### ADDITIONAL NOTES & EXAMPLES

Example 1 is a system of compressed air energy storage, the system comprising: a motor powered by an energy source; a compressor operatively connected to the motor, the compressor defining a chamber, the compressor operable to pressurize a working fluid by altering a volume of the chamber between an expanded state and a compressed state; and a compressible heat exchanger within the chamber to transfer heat between the working fluid and the compressible heat exchanger.

In Example 2, the subject matter of Example 1 includes, an inlet valve configured to fluidically connect the chamber to a source to fill the chamber with the working fluid when the volume of the chamber is in the expanded state; and an outlet valve configured to fluidically connect the chamber to a storage tank to release the working fluid from the chamber after the compressor has pressurized the working fluid and the volume of the chamber is in the compressed state.

In Example 3, the subject matter of Examples 1-2 includes, wherein the compressor further comprises: a piston within the chamber; and a piston rod connected to the piston such that the piston rod engages with the piston to alter the volume of the chamber between the expanded state and the compressed state.

In Example 4, the subject matter of Example 3 includes, wherein the compressible heat exchanger fills thirty percent of the chamber when the volume of the chamber is in the expanded state, and wherein the compressible heat exchanger essentially fills the chamber when the volume of the chamber is in the compressed state.

In Example 5, the subject matter of Examples 3-4 includes, wherein the compressible heat exchanger comprises a foam configured to expand and contract as the volume of the chamber changes from the expanded state and the compressed state.

In Example 6, the subject matter of Example 5 includes, wherein the foam defines pores and includes structural ligaments extending between adjacent pores, and wherein the structural ligaments have widths of less than one hundred micron.

In Example 7, the subject matter of Examples 5-6 includes, wherein the compressible heat exchanger comprises a mass loading between two and five as compared to the working fluid in the chamber.

In Example 8, the subject matter of Examples 5-7 includes, wherein a work required to compress the compressible heat exchanger is less than two percent of a work required to compress the working fluid within the chamber.

In Example 9, the subject matter of Examples 5-8 includes, wherein the foam comprises a polymer.

In Example 10, the subject matter of Examples 4-9 includes, wherein the compressible heat exchanger comprises a wire mesh configured to expand and compress with the chamber.

In Example 11, the subject matter of Examples 4-10 includes, wherein the compressible heat exchanger comprises a foam impregnated with a wire mesh, and wherein the compressible heat exchanger is configured to expand and compress with the chamber.

In Example 12, the subject matter of Examples 1-11 includes, a pump operatively connected to the motor and fluidically connected to the chamber, wherein the pump is operable to fill the chamber with a processing fluid to move the volume of the chamber to the compressed state and pressurize the working fluid within the chamber, and wherein the pump is operable to drain the processing fluid from the chamber to actuate the volume of the chamber to the expanded state and to permit the working fluid to fill the chamber.

Example 13 is a compressor for a stored energy system, the compressor comprising: a housing defining a volume; an actuator operable to expand the volume and compress the volume; and a heat exchanger located at least partially within the housing, the heat exchanger is configured to: compress when the actuator compresses the volume; expand when the actuator expands the volume; and transfer heat with a working fluid.

In Example 14, the subject matter of Example 13 includes, an inlet valve configured to fluidically connect the housing to a source to fill the housing with the working fluid when the volume of the housing is expanded; and an outlet valve configured to fluidically connect the housing to a storage tank to release the working fluid from the housing after the compressor has pressurized the working fluid and the volume of the housing is compressed.

In Example 15, the subject matter of Examples 13-14 includes, wherein the heat exchanger fills thirty percent of the housing when the volume of the housing is expanded, and wherein the heat exchanger essentially fills the housing when the volume of the housing is compressed.

In Example 16, the subject matter of Examples 13-15 includes, wherein the heat exchanger comprises a foam configured to expand and contract as the volume of the housing expands and compresses.

In Example 17, the subject matter of Example 16 includes, wherein the foam defines pores and includes structural ligaments extending between adjacent pores, and wherein the structural ligaments have widths of less than one hundred microns.

In Example 18, the subject matter of Example 17 includes, wherein the heat exchanger comprises a mass loading between two and five as compared to the working fluid in the housing.

In Example 19, the subject matter of Example 18 includes, wherein a work required to compress the heat exchanger is less than two percent of a work required to compress the working fluid within the housing.

In Example 20, the subject matter of Examples 16-19 includes, wherein the foam comprises a polymer.

In Example 21, the subject matter of Examples 13-20 includes, wherein the heat exchanger comprises a wire mesh configured to expand and compress with the housing.

In Example 22, the subject matter of Examples 13-21 includes, wherein the heat exchanger comprises a foam impregnated with a wire mesh, and wherein the heat exchanger is configured to expand and compress with the housing.

Example 23 is an apparatus comprising means to implement of any of Examples 1-22.

Example 24 is a system to implement of any of Examples 1-22.

Example 25 is a method to implement of any of Examples 1-22.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system of compressed air energy storage, the system comprising:
a motor powered by an energy source;
a compressor operatively connected to the motor, the compressor defining a chamber, the compressor operable to pressurize a working fluid by altering a volume of the chamber between an expanded state and a compressed state; and
a compressible heat exchanger within the chamber to transfer heat between the working fluid and the compressible heat exchanger.

2. The system of claim 1, further comprising:
an inlet valve configured to fluidically connect the chamber to a source to fill the chamber with the working fluid when the volume of the chamber is in the expanded state; and
an outlet valve configured to fluidically connect the chamber to a storage tank to release the working fluid from the chamber after the compressor has pressurized the working fluid and the volume of the chamber is in the compressed state.

3. The system of claim 1, wherein the compressor further comprises:
a piston within the chamber; and
a piston rod connected to the piston such that the piston rod engages with the piston to alter the volume of the chamber between the expanded state and the compressed state.

4. The system of claim 3, wherein the compressible heat exchanger fills thirty percent of the chamber when the volume of the chamber is in the expanded state, and wherein the compressible heat exchanger essentially fills the chamber when the volume of the chamber is in the compressed state.

5. The system of claim 3, wherein the compressible heat exchanger comprises a foam configured to expand and contract as the volume of the chamber changes from the expanded state and the compressed state.

6. The system of claim 5, wherein the foam defines pores and includes structural ligaments extending between adjacent pores, and wherein the structural ligaments have widths of less than 100 micron.

7. The system of claim 5, wherein the compressible heat exchanger comprises a mass loading between two and five as compared to the working fluid in the chamber.

8. The system of claim 5, wherein a work required to compress the compressible heat exchanger is less than two percent of a work required to compress the working fluid within the chamber.

9. The system of claim 5, wherein the foam comprises a polymer.

10. The system of claim 4, wherein the compressible heat exchanger comprises a wire mesh configured to expand and compress with the chamber.

11. The system of claim 4, wherein the compressible heat exchanger comprises a foam impregnated with a wire mesh, and wherein the compressible heat exchanger is configured to expand and compress with the chamber.

12. The system of claim 1, further comprising:
a pump operatively connected to the motor and fluidically connected to the chamber, wherein the pump is operable to fill the chamber with a processing fluid to move the volume of the chamber to the compressed state and pressurize the working fluid within the chamber, and wherein the pump is operable to drain the processing fluid from the chamber to actuate the volume of the chamber to the expanded state and to permit the working fluid to fill the chamber.

13. A compressor for a stored energy system, the compressor comprising:
a housing defining a volume;
an actuator operable to expand the volume and compress the volume; and
a heat exchanger located at least partially within the housing, the heat exchanger is configured to:
compress when the actuator compresses the volume;
expand when the actuator expands the volume; and
transfer heat with a working fluid.

14. The compressor of claim 13, further comprising:
an inlet valve configured to fluidically connect the housing to a source to fill the housing with the working fluid when the volume of the housing is expanded; and
an outlet valve configured to fluidically connect the housing to a storage tank to release the working fluid from the housing after the compressor has pressurized the working fluid and the volume of the housing is compressed.

15. The compressor of claim 13, wherein the heat exchanger fills thirty percent of the housing when the volume of the housing is expanded, and wherein the heat exchanger essentially fills the housing when the volume of the housing is compressed.

16. The compressor of claim 13, wherein the heat exchanger comprises a foam configured to expand and compress as the volume of the housing expands and compresses.

17. The compressor of claim 16, wherein the foam defines pores and includes structural ligaments extending between adjacent pores, and wherein the structural ligaments have widths of less than fifty micron.

18. The compressor of claim 17, wherein the heat exchanger comprises a mass loading between two and five as compared to the working fluid in the housing.

19. The compressor of claim 18, wherein a work required to compress the heat exchanger is less than one-tenth of one percent of a work required to compress the working fluid within the housing.

20. The compressor of claim 16, wherein the foam comprises a polymer.

21. The compressor of claim 13, wherein the heat exchanger comprises a wire mesh configured to expand and compress with the housing.

22. The compressor of claim 13, wherein the heat exchanger comprises a foam impregnated with a wire mesh, and wherein the heat exchanger is configured to expand and compress with the housing.
